(19) United States
(12) Patent Application Publication
(10) Pub. No.: US 2020/0234191 A1
(43) Pub. Date: Jul. 23, 2020

(54) TRAVEL MODEL GENERATION SYSTEM, VEHICLE IN TRAVEL MODEL GENERATION SYSTEM, AND PROCESSING METHOD

(71) Applicant: HONDA MOTOR CO., LTD., Tokyo (JP)

(72) Inventor: Yoshimitsu Murahashi, Wako-shi (JP)

(73) Assignee: HONDA MOTOR CO., LTD., Tokyo (JP)

(21) Appl. No.: 16/841,804

(22) Filed: Apr. 7, 2020

Related U.S. Application Data
(63) Continuation of application No. PCT/JP2017/037583, filed on Oct. 17, 2017.

(51) Int. Cl. G06N 20/00; G08G 1/01; G07C 5/00; G06N 5/04; G06N 5/02; G05B 13/02; G05D 1/00; G05D 1/02; H04W 4/46

(52) U.S. Cl. CPC G06N 20/00; G08G 1/01; G07C 5/008; G06N 5/04; G05D 2201/0213; G05B 13/0265; G05D 1/0088; G05D 1/0221; H04W 4/46; G06N 5/02

(57) ABSTRACT

A travel model generation system dial generates a travel model of a vehicle on the basis of travel data of the vehicle, comprises: an obtainment unit configured to obtain the travel data from the vehicle; a filtering unit configured to exclude, from the travel data obtained by the obtainment unit, travel data to be excluded from learning; a generating unit configured to learn travel data from which the travel data to be excluded from the learning has been excluded by the filtering unit and generate a first travel model on the basis of a result of the learning; and a processing unit configured to process the travel data excluded from the learning in accordance with a condition associated with the travel data excluded from the learning.

### CROSS-REFERENCE TO RELATED APPLICATION(S)

This application is a continuation of International Patent Application No. PCT/JP2017/037583 tiled on Oct. 17, 2017, the entire disclosures of which is incorporated herein by reference.

### TECHNICAL FIELD

The present invention relates to a travel model generation system that generates a travel model of a vehicle, a vehicle in the travel model generation system and a processing method.

### BACKGROUND ART

When implementing automated driving, automated driving support, and the like, there are situations where travel data is collected from a vehicle driven by an expert driver, and machine learning is carried out using the collected travel data as training data.

When carrying out machine learning, it is important to ensure that the accuracy of the learning does not drop. Japanese Patent Laid-Open No. 2016-191975 describes using a target domain and a source domain determined to be valid for transfer learning, and generating feature data for identification by executing machine learning that has adopted transfer learning. Japanese Patent Laid-Open No. 2016-191975 furthermore describes determining whether or not a source domain is valid for transfer learning in order to exclude source domains which are likely to produce negative transfers from the feature data for identification.

According to Japanese Patent Laid-Open No. 2016-191975, if the source domain is constituted by images having features that differ greatly from the features of the images included in the target domain, that source domain is prevented from being used to generate the feature data for identification.

When implementing automated driving, automated driving support, and the like, even if travel data obtained from a vehicle differs greatly from the features of training data, that travel data can nevertheless be extremely important data. For example, data indicating how an expert driver drives in a situation such as when a boulder or the like is present in the road due to an earthquake can be extremely important data for implementing automated driving, automated driving support, and the like. Accordingly, with a configuration that excludes travel data that differs greatly from the features of training data, a travel model capable of handling a situation such as that described above cannot be created.

### SUMMARY OF INVENTION

The present invention provides a travel model generation system, a vehicle in a travel model generation system, and a processing method that prevent a drop in learning accuracy by appropriately processing data having features that differ greatly from features of training data.

A travel model generation system according to the present invention is a travel model generation system that generates a travel model of a vehicle on the basis of travel data of the vehicle, and includes: an obtainment unit configured to obtain the travel data from the vehicle; a filtering unit configured to exclude, from the travel data obtained by the obtainment unit, travel data to be excluded from learning; a generating unit configured to learn travel data from which the travel data to be excluded from the learning has been excluded by the filtering unit and generate a first travel model on the basis of a result of the learning; and a processing unit configured to process the travel data excluded from the learning in accordance with a condition associated with the travel data excluded from the learning.

A vehicle according to the present invention is a vehicle in a travel model generation system that generates a travel model of a vehicle on the basis of travel data of the vehicle, the vehicle including: an obtainment unit configured to obtain the travel data from the vehicle; a filtering unit configured to exclude, from the travel data obtained by the obtainment unit, travel data to be excluded from learning in a travel model generating apparatus that generates the travel model of the vehicle; a transmitting unit configured to transmit, to the travel model generating apparatus, travel data from which the travel data to be excluded from the learning has been excluded by the filtering unit; and a processing unit configured to process the travel data excluded from the learning in accordance with a condition associated with the travel data excluded from the learning.

A processing method according to the present invention is a processing method executed in a travel model generation system that generates a travel model of a vehicle on the basis of travel data of the vehicle, the method including: an obtainment step of obtaining the travel data from the vehicle; a filtering step of excluding, from the travel data obtained in the obtainment step, travel data to be excluded from learning; a generating step of learning travel data from which the travel data to be excluded from the learning has been excluded in the filtering step and generating a first travel model on the basis of a result of the learning: and a processing step of processing the travel data excluded from the learning in accordance with a condition associated with the travel data excluded from the learning.

A processing method according to the present invention is a processing method executed in a vehicle of a travel model generation system that generates a navel model of a vehicle on the basis of travel data of the vehicle, the method including: an obtainment step of obtaining the travel data from the vehicle; a filtering step of excluding, from the travel data obtained in the obtainment step, travel data to be excluded from learning in a travel model generating apparatus that generates the travel model of the vehicle; a transmitting step of transmitting, to the travel model generating apparatus, travel data from which the travel data to be excluded from the learning has been excluded in the filtering step; and a processing step of processing the travel data excluded from the learning in accordance with a condition associated with the travel data excluded from the learning.

According to the present invention, a drop in learning accuracy can be prevented by appropriately processing data having features that differ geatly from features of training data.

Further features of the present invention will become apparent from the following description of exemplary embodiments with reference to the attached drawings.

### BRIEF DESCRIPTION OF DRAWINGS

The appended drawings, which are included in and constitute part of the specification, illustrate embodiments of the present invention, and along with those descriptions serve to illustrate the principles of the present invention.

FIG. 1 is a diagram illustrating the configuration of a travel model generation system.

FIG. 2A is a diagram illustrating the configuration of a server.

FIG. 2B is a diagram illustrating the configuration of a wireless base station.

FIG. 3 is a block diagram illustrating a vehicle control system.

FIG. 4 is a block diagram illustrating a vehicle control system.

FIG. 5 is a block diagram illustrating a vehicle control system.

FIG. 6 is a diagram illustrating a block configuration leading up to the generation of a travel model in a server.

FIG. 7 is a flowchart illustrating processing leading up to the storage of a generated travel model.

FIG. 8 is a flowchart illustrating a filtering process.

FIG. 9 is a flowchart illustrating a filtering process.

FIG. 10 is a flowchart illustrating a filtering process.

FIG. 11A is a diagram illustrating a specific scene.

FIG. 11B is a diagram illustrating a specific scene.

FIG. 12 is a diagram illustrating a block configuration leading up to actuator control in a vehicle.

FIG. 13 is a flowchart illustrating processing leading up to probe data output.

FIG. 14 is a flowchart illustrating a filtering process.

FIG. 15 is a flowchart illustrating as filtering process.

FIG. 16 is a flowchart illustrating a filtering process.

### DESCRIPTION OF EMBODIMENTS

### First Embodiment

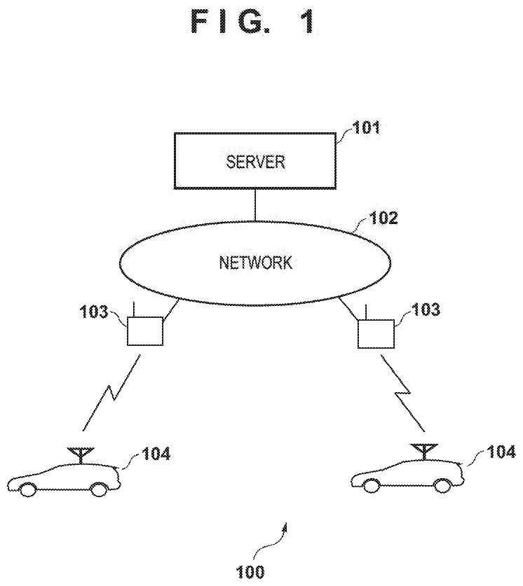

FIG. 1 is a diagram illustrating the configuration of a travel model generation system for automated driving or automated driving support, according to the present embodiment. As illustrated in FIG. 1, in a travel model generation system 100, a server 101 and a wireless base station 103 are configured to be capable of communicating with each other over a network 102 including a medium that is wired, wireless, or the like. A vehicle 104 sends probe data. Here, “probe data” is travel data used to generate a travel model for automated driving, automated driving support, or the like, and includes, for example, vehicle movement information such as speed and acceleration, driver comment information input through an HMI (human-machine interface), and so on. Note that the present embodiment will describe the vehicle 104 as a vehicle driven by an expert driver (a veteran driver). Additionally, there are cases where the vehicle 104 is a vehicle in which a travel model generated by the server 101 is loaded, and that constitutes an automated driving support system.

The wireless base station 103 is provided in public equipment such as a traffic signal, for example, and transmits the probe data sent from the vehicle 104 to the server 101 over the network 102. Although FIG. 1 illustrates the wireless base station 103 and the vehicle 104 as being in a one-to-one relationship for descriptive purposes, there are also cases where a plurality of vehicles 104 correspond to a single wireless base station 103.

The server 101 learns the probe data collected from the vehicle 104 and generates a travel model for automated driving, automated driving support, and the like. The travel model includes a basic travel model for curves, intersections, following travel, and the like, as well as a risk avoidance model for predicting pedestrians running out into traffic, vehicles catting into traffic, and the like. The server 101 can also collect probe data from the vehicle 104 in which a travel model generated by the server 101 is loaded, to carry out further learning.

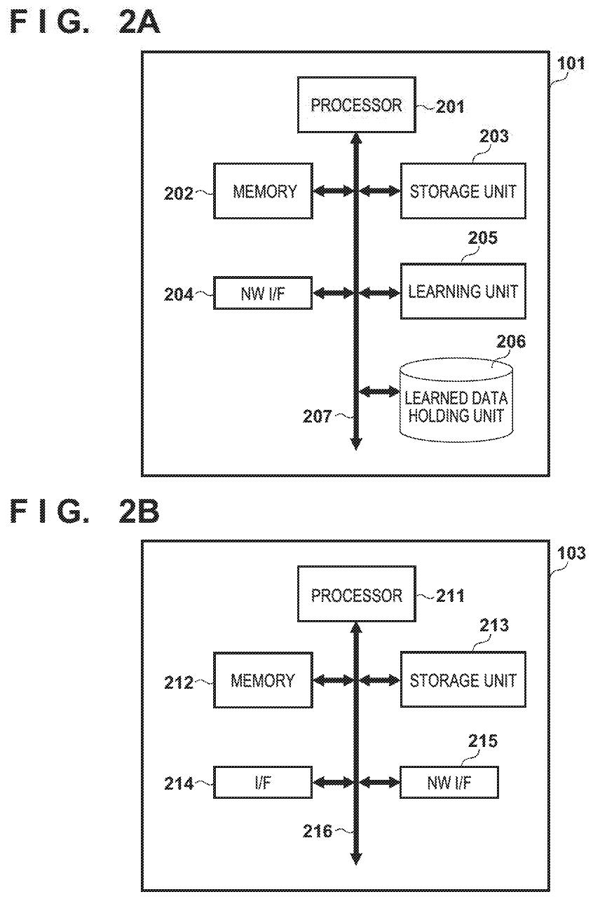

FIG. 2A is a diagram illustrating the configuration of the server 101. A processor 201 comprehensively controls the server 101, and implements operations of the present embodiment by, for example, reading out a control program stored in a storage unit 203 into memory 202, which is an example of a storage medium, and executing the control program. A network interface (NW I/F) 204 is an interface for enabling communication with the network 102, and has a configuration based on the medium of the network 102.

A learning unit 205 includes, for example, a GPU capable of constructing a model of a deep neural network, and recognizes the surrounding environment of the vehicle 104 on the basis of surrounding environment information, GPS position information, and the like included in the probe data. The travel model and so on generated by the learning unit 205 are stored in a learned data holding unit 206. The blocks illustrated in FIG. 2A are configured to be capable of communicating with each other over a bus 207. Additionally, the learning unit 205 can obtain map information of the area around where the vehicle 104 is located via GPS, and can, for example, generate a 3D map on the basis of the surrounding environment information included in the probe data and the map information of the area around where the vehicle 104 is located.

FIG. 2B is a diagram illustrating the configuration of the wireless base station 103. A processor 211 comprehensively controls the wireless base station 103 by, for example, reading out a control program stored in a storage unit 213 into memory 212 and executing the control program. A network interface (NW I/F) 215 is an interface for enabling communication with the network 102, and has a configuration based on the medium of the network 102. An interface (I/F) 214 is a wireless communication interface with the vehicle 104, and the wireless base station 103 receives, through the I/F 214, the probe data received from the vehicle 104. The received probe data is subjected to data conversion, and is then transmitted to the server 101 over the network 102 through the NW I/F 215. The blocks illustrated in FIG. 2B are configured to be capable of communicating with each other over a bus 216.

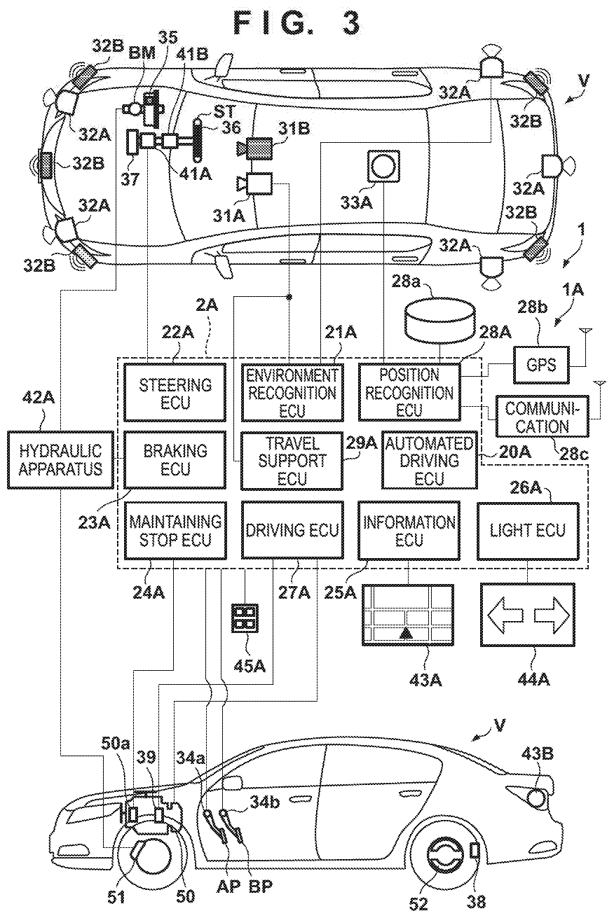

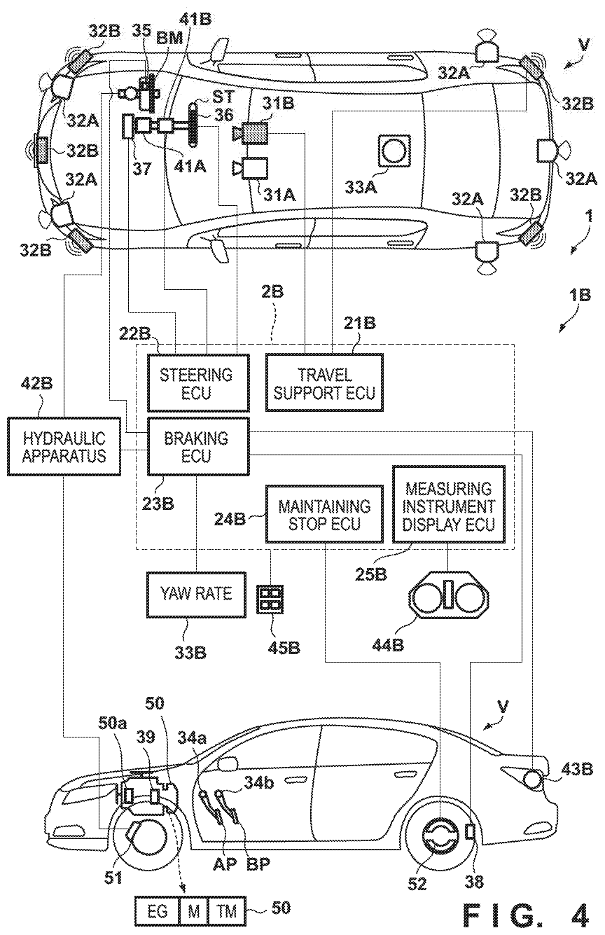

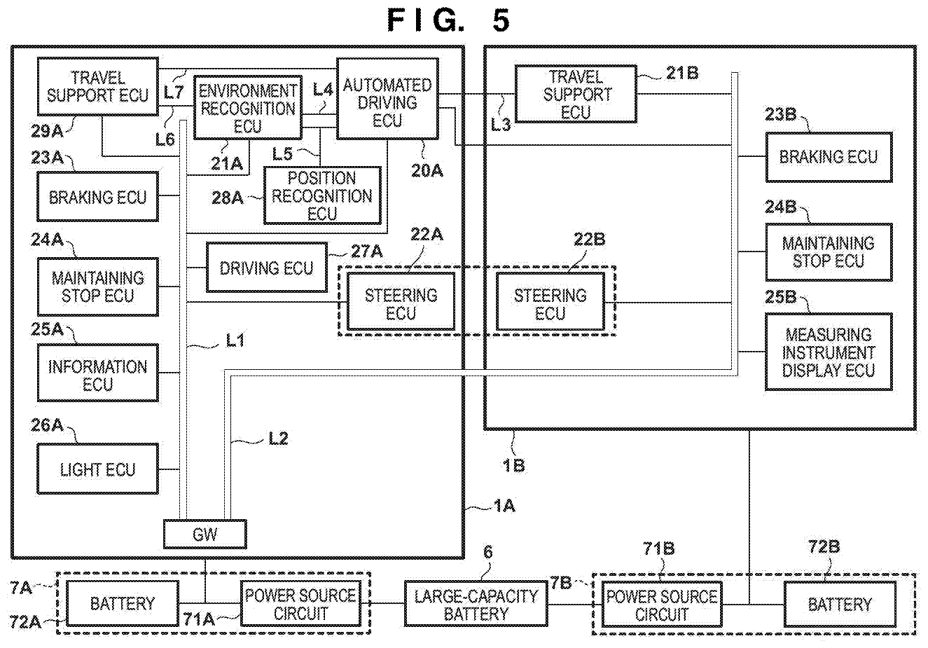

FIG. 3 to FIG. 5 are block diagrams illustrating a vehicle control system 1 according to the present embodiment. The control system 1 controls a vehicle V. An overview of the vehicle V is illustrated in FIG. 3 and FIG. 4, both as a plan view and as a side view. The vehicle V is, for example, a sedan-type four-wheeled passenger vehicle. The control system 1 includes a control apparatus 1A and a control apparatus 1B. FIG. 3 is a block diagram illustrating the control apparatus 1A, and FIG. 4 is a block diagram illustrating the control apparatus 1B. FIG. 5 mainly illustrates communication lines between the control apparatus 1A and the control apparatus 1B, as well as the configuration of a power source.

The control apparatus 1A and the control apparatus 1B implement some of the functions realized by the vehicle V in an overlapping and redundant manner. This makes it possible to improve the reliability of the system. For example, the control apparatus 1A carries out automated driving control, normal operation control during manual driving, as well as travel support control pertaining to danger avoidance and the like. The control apparatus 1B primarily handles travel support control pertaining to danger avoidance and the like. “Travel support” may also be called “driving support”. By using the control apparatus 1A and the control apparatus 1B to carry out different control processes while also making functions redundant, the reliability can be improved while distributing the control processes.

The vehicle V according to the present embodiment is a parallel-type hybrid vehicle, and FIG. 4 schematically illustrates the configuration of a power plant 50 that outputs drive force for rotating driving wheels of the vehicle V. The power plant 50 includes an internal combustion engine EG, a motor M, and an automatic transmission TM. The motor M can be used not only as a drive source when causing the vehicle V to accelerate, but also as an electric generator during deceleration and the like (regenerative braking).

### Control Apparatus 1A

The configuration of the control apparatus 1A will be described with reference to FIG. 3. The control apparatus 1A includes an ECU group (control unit group) 2A. The ECU group 2A includes a plurality of ECUs 20A to 29A. Each ECU includes a processor such as a CPU, a storage device such as semiconductor memory, an interface with external devices, and the like. The storage device stores programs executed by the processor, the data used in processing by the processor, and so on. Each ECU may include a plurality of processors, storage devices, interfaces, and so on. Note that the number of ECUs, the functions handled by the ECUs, and so on can be designed as appropriate, and can be set at a finer or broader level than that described in the present embodiment. Note also that names of the main functions of the ECUs 20A to 29A are denoted in FIG. 3 and FIG. 5. For example, the ECU 20A is denoted as “automated driving ECU”.

The ECU 20A executes control pertaining to automated driving, as travel control of the vehicle V. In automated driving, at least one of powering the vehicle V (causing the vehicle V to accelerate and the like using the power plant 50), steering, and braking is carried out automatically without driving operations made by a driver. In the present embodiment, this also includes a case where the powering, steering, and braking are carried out automatically.

The ECU 21A is an environment recognition unit that recognizes the travel environment of the vehicle V on the basis of detection results from detection units 31A and 32A that detect surrounding conditions of the vehicle V. The ECU 21A generates object data, described later, as surrounding environment information.

In the present embodiment, the detection unit 31A is an image capturing device that detects objects in the periphery of the vehicle V by capturing images (the detection unit 31A may be called a “camera 31A” hereinafter). The camera 31A is provided on a forward part of the roof of the vehicle V so as to be capable of capturing images to the front of the vehicle V. By analyzing the images captured by the cameras 31A, the contours of objects can be extracted, lane dividing lines on the road (white lines and the like) can be extracted, and so on.

In the present embodiment, the detection unit 32A is LIDAR (Light Detection and Ranging) (laser radar) that detects objects in the periphery of the vehicle V using light (the detection unit 32A may be called “LIDAR 32A” hereinafter), and detects objects in the periphery of the vehicle V, measures the distance to objects, and so on. In the present embodiment, five of the LIDAR 32A are provided: one on each front corner of the vehicle V, one in the rear center, and one each on the rear sides of the vehicle V. The number, placement, and so on of the LIDAR 32A can be selected as appropriate.

The ECU 29A is a travel support unit that executes control pertaining to travel support (i.e., driving support) as travel control for the vehicle V, on the basis of detection results from the detection unit 31A.

The ECU 22A is a steering control unit that controls an electric power steering apparatus 41A. The electric power steering apparatus 41A includes a mechanism for turning the front wheels in response to a driver making a driving operation (turning operation) on a steering wheel ST. The electric power steering apparatus 41A also includes a motor that assists the turning operation or for producing drive force for automatically turning the front wheels, a sensor that detects a rotation amount of the motor, a torque sensor that detects steering torque acting on the driver, and so on.

The ECU 23A is a braking control unit that controls a hydraulic apparatus 42A. A braking operation made by the driver on a brake pedal BP is transformed into hydraulic pressure in a brake master cylinder BM and then transmitted to the hydraulic apparatus 42A. The hydraulic apparatus 42A is an actuator capable of controlling the hydraulic pressure of operating fluid supplied to brake apparatuses (e.g., disk brake apparatuses) 51 provided in each of the four wheels on the basis of the hydraulic pressure transmitted from the brake master cylinder BM, and the ECU 23A controls the driving of electromagnetic valves and the like provided in the hydraulic apparatus 42A. In the present embodiment, the ECU 23A and the hydraulic apparatus 42A constitute an electric servo brake, and the ECU 23A controls, for example, the distribution of braking force by the four brake apparatuses 51 and braking force produced by the regenerative braking of the motor M.

The ECU 24A is a stop maintenance control unit that controls an electric parking lock apparatus 50a provided in the automatic transmission TM. The electric parking lock apparatus 50a includes a mechanism that locks an internal mechanism of the automatic transmission TM mainly when a P range(parking range) is selected. The ECU 24A can control the electric parking lock apparatus 50a to lock and unlock.

The ECU 25A is a vehicle interior notification control unit that controls an information output apparatus 43A which provides information in the vehicle. The information output apparatus 43A includes a display apparatus such as a heads-up display, an audio output apparatus, and the like, for example. A vibrating apparatus may be included as well. The ECU 25A causes the information output apparatus 43A to output various types of information such as vehicle speed, outside temperature, and the like, as well as route guidance information and so on, for example.

The ECU 26A is a vehicle exterior notification control unit that controls an information output apparatus 44A which provides information outside the vehicle. In the present embodiment, the information output apparatus 44A is directional indicators (hazard lamps), and the ECU 26A can communicate a travel direction of the vehicle V to the exterior of the vehicle by controlling flashing of the information output apparatus 44A as directional indicators, as well as increase the amount of attention paid to the vehicle V from outside the vehicle by controlling the flashing of the information output apparatus 44A as hazard lamps.

The ECU 27A is a drive control unit that controls the power plant 50. Although the one ECU 27A is assigned to the power plant 50 in the present embodiment, one ECU may be assigned to each of the internal combustion engine EG, the motor M, and the automatic transmission TM. The ECU 27A controls outputs of the internal combustion engine EG and the motor M, switches the gear ratio of the automatic transmission TM, and so on in accordance with a driving operation made by the driver, the vehicle speed, and the like detected by an operation detection sensor 34a provided in an accelerator pedal AP, an operation detection sensor 34b provided in the brake pedal BP, and so on, for example. Note that a rotation number sensor 39 that detects the number of rotations of an output shaft of the automatic transmission TM is provided in the automatic transmission TM as a sensor that detects a travel state of the vehicle V. The vehicle speed of the vehicle V can be calculated from a detection result from the rotation number sensor 39.

The ECU 28A is a position recognition unit that recognizes the current position, path and so on of the vehicle V. The ECU 28A controls a gyrosensor 33A, a GPS sensor 28b, and a communication apparatus 28c, and processes information of detection results or communication results therefrom. The gyrosensor 33A detects rotational movement of the vehicle V. The path of the vehicle V can be determined from the detection results from the gyrosensor 33A. The GPS sensor 28b detects the current position of the vehicle V. The communication apparatus 28c communicates wirelessly with a server that provides map information, traffic information, and the like, and obtains that information. A database 28a can store highly-accurate map information, and the ECU 28A can specify the position of the vehicle V in a lane with a high level of accuracy on the basis of this map information and the like. The communication apparatus 28c can also be used in vehicle-to-vehicle communication, road-to-vehicle communication, and the like and can, for example, obtain information of another vehicle.

An input apparatus 45A is disposed within the vehicle so as to be operable by the driver, and receives instructions, information input, and the like from the driver.

### Control Apparatus 1B

The configuration of the control apparatus 1B will be described with reference to FIG. 4. The control apparatus 1B includes an ECU group (control unit group) 2B. The ECU group 2B includes a plurality of ECUs 21B to 25B. Each ECU includes a processor such as a CPU or a GPU, a storage device such as semiconductor memory, an interface with external devices, and the like. The storage device stores programs executed by the processor, the data used in processing by the processor, and so on. Each ECU may include a plurality of processors, storage devices, interfaces, and so on. Note that the number of ECUs, the functions handled by the ECUs, and so on can be designed as appropriate, and can be set at a finer or broader level than that described in the present embodiment. Note also that like the ECU group 2A, names of the main functions of the ECUs 21B to 25B are denoted in FIG. 4 and FIG. 5.

The ECU 21B is an environment recon ration unit that recognizes the travel environment of the vehicle V, and is also a travel support unit that executes control pertaining to travel support (i.e., driving support) as travel control for the vehicle V, on the basis of detection results from detection units 31B and 32B that detect surrounding conditions of the vehicle V. The ECU 21B generates object data, described later, as surrounding environment information.

Although the present embodiment describes a configuration in which the ECU 21B has an environment recognition function and a travel support function, an ECU may be provided for each of these functions, as with the ECU 21A and the ECU 29A of the control apparatus 1A. Conversely, the control apparatus 1A may be configured so that the functions of the ECU 21A and the ECU 29A are realized by a single ECU, as with the ECU 21B.

In the present embodiment, the detection unit 31B is an image capturing device that detects objects in the periphery of the vehicle V by capturing images (the detection unit 31B may be called a “camera 31B” hereinafter). The camera 31B is provided on a forward part of the roof of the vehicle V so as to be capable of capturing images to the front of the vehicle V. By analyzing the images captured by the cameras 31B, the contours of objects, lane dividing lines on the road (white lines and the like), and the like can be extracted. In the present embodiment, the detection unit 32B is millimeter wave radar that detects objects in the periphery of the vehicle V using radio waves (the detection unit 32B may be called “radar 32B” hereinafter), and detects objects in the periphery of the vehicle V, measures the distance to objects, and so on. In the present embodiment, five of the radar 32B are provided: one in the front-center of the vehicle V, as well as one each on the front and rear corners of the vehicle V. The number, placement, and so on of the radar 32B can be selected as appropriate.

The ECU 22B is a steering control unit that controls an electric power steering apparatus 41B. The electric power steering apparatus 41B includes a mechanism for turning the front wheels in response to a driver making a driving operation (turning operation) on a steering wheel ST. The electric power steering apparatus 41B also includes a motor that assists the turning operation or for producing drive force for automatically turning the front wheels, a sensor that detects a rotation amount of the motor, a torque sensor that detects steering torque acting on the driver, and so on. A steering angle sensor 37 is also electrically connected to the ECU 22B by a communication line L2, which will be described later, and the electric power steering apparatus 41B can be controlled on the basis of detection results from the steering angle sensor 37. The ECU 22B can obtain detection results from a sensor 36 that detects whether or not the driver is gripping the steering wheel ST, and can therefore monitor a state of the grip of the driver.

The ECU 23B is a braking control unit that controls a hydraulic apparatus 42B. A braking operation made by the driver on the brake pedal BP is transformed into hydraulic pressure in the brake master cylinder BM and then transmitted to the hydraulic apparatus 42B. The hydraulic apparatus 42B is an actuator capable of controlling the hydraulic pressure of operating fluid supplied to the brake apparatuses 51 provided in each of the wheels on the basis of the hydraulic pressure transmitted from the brake master cylinder BM, and the ECU 23B controls the driving of electromagnetic valves and the like provided in the hydraulic apparatus 42B.

In the present embodiment, a wheel speed sensor 38 provided in each of the four wheels, a yaw rate sensor 33B, and a pressure sensor 35 that detects the pressure in the brake master cylinder BM are electrically connected to the ECU 23B and the hydraulic apparatus 42B, and an ABS function, traction control, and an attitude control function of the vehicle V are implemented on the basis of detection results therefrom. For example, the ECU 23B adjusts the braking force of each of the four wheels on the basis of the detection result from the wheel speed sensor 38 provided in the corresponding wheel to suppress slippage in each wheel. The ECU 23B also adjusts the braking force of each wheel on the basis of a rotational angular velocity about a vertical axis of the vehicle V, detected by the yaw rate sensor 33B, to suppress sudden changes in the attitude of the vehicle V.

The ECU 23B also fictions as a vehicle exterior notification control unit that controls an information output apparatus 43B which provides information outside the vehicle. In the present embodiment, the information output apparatus 43B is brake lamps, and the ECU 23B can light the brake lamps during braking and the like. This makes it possible to prompt a following vehicle to pay more attention to the vehicle V.

The ECU 24B is a stop maintenance control unit that controls an electric parking brake apparatus (e.g., a drum brake) 52 provided in a rear wheel. The electric parking brake apparatus 52 includes a mechanism that locks the rear wheel. The ECU 24B can control the electric parking brake apparatus 52 to lock and unlock the rear wheel.

The ECU 25B is a vehicle interior notification control unit that controls an information output apparatus 44B which provides information in the vehicle. In the present embodiment, the information output apparatus 44B includes a display apparatus disposed in an instrument panel. The ECU 25B can cause the information output apparatus 11B to output various types of information, such as the vehicle speed, fuel economy, and so on.

An input apparatus 45B is disposed within the vehicle so as to be operable by the driver, and receives instructions, information input, and the like from the driver.

### Communication Lines

An example of communication lines in the control system 1, which communicably connect the ECUs, will be described with reference to FIG. 5. The control system 1 includes wired communication lines L1 to L7. The ECUs 20A to 27A and 29A of the control apparatus 1A are connected to the communication line L1. Note that the ECU 28A may also be connected to the communication line L1.

The ECUs 21B to 25B of the control apparatus 1B are connected to the communication line L2. The ECU 20A of the control apparatus 1A is also connected to the communication line L2. The communication line L3 connects the ECU 20A and the ECU 21B. The communication line L4 connects the ECU 20A and the ECU 21A. The communication line L5 connects the ECU 20A, the ECU 21A, and the ECU 28A. The communication line L6 connects the ECU 29A and the ECU 21A. The communication line L7 connects the ECU 29A and the ECU 20A.

Although protocols of the communication lines L1 to L7 may be the same or different, the protocols may be varied in accordance with the communication environments, such as communication speeds, communication amounts, robustness, and the like. For example, the communication lines L3 and L4 may use Ethernet (registered trademark) from the standpoint of communication speed. For example, the communication lines L1, L2, and L5 to L7 may use CAN.

The control apparatus 1A includes a gateway GW. The gateway GW relays the communication line L1 and the communication line L2. As such, for example, the ECU 21B can output control commands to the ECU 27A via the communication line L2, the gateway GW, and the communication line L1.

### Power Source

A power source of the control system I will be described with reference to FIG. 5. The control system 1 includes a large-capacity battery 6, a power source 7A, and a power source 7B. The large-capacity battery 6 is a battery for driving the motor M, and is also a battery charged by the motor M.

The power source 7A is a power source that supplies electricity to the control apparatus 1A, and includes a power source circuit 71A and a battery 72A. The power source circuit 71A is a circuit that supplies electricity from the large-capacity battery 6 to the control apparatus 1A, and for example, steps down an output voltage of the large-capacity battery 6 (e.g., 190 V) to a reference voltage (e.g., 12 V). The battery 72A is, for example, a 12 V lead battery. By providing the battery 72A, electricity can be supplied to the control apparatus 1A even when the supply of electricity from the large-capacity battery 6, the power source circuit 71A, or the like has been cut off or has dropped.

The power source 7B is a power source that supplies electricity to the control apparatus 1B, and includes a power source circuit 71B and a battery 72B. The power source circuit 71B is a circuit similar to the power source circuit 71A, and is a circuit that supplies electricity from the large-capacity battery 6 to the control apparatus 1B. The battery 72B is a battery similar to the battery 72A, and is, for example, a 12 V lead battery. By providing the battery 72B, electricity can be supplied to the control apparatus 1B even when the supply of electricity from the large-capacity battery 6, the power source circuit 71B, or the like has been cut off or has dropped.

### Redundancy

The commonality of functions of the control apparatus 1A and the control apparatus 1B will be described. The reliability of the control system 1 can be improved by making identical functions redundant. Furthermore, for some redundant functions, different functions are achieved, rather than replicating the exact same functions. This suppresses an increase in costs resulting from making the functions redundant.

### Actuator System

### Steering

The control apparatus 1A includes the electric power steering apparatus 41A, as well as the ECU 22A that controls the electric power steering apparatus 41A. The control apparatus 1B includes the electric power steeling apparatus 41B, as well as the ECU 22B fiat controls the electric power steering apparatus 41B.

### Braking

The control apparatus 1A includes the hydraulic apparatus 42A, as well as the ECU 23A that controls the hydraulic apparatus 42A. The control apparatus 1B includes the hydraulic apparatus 42B, as well as the ECU 23B that controls the hydraulic apparatus 42B. Both of these can be used for the braking of the vehicle V. However, while the primary function of the braking mechanism of the control apparatus 1A is to distribute the braking force produced by the brake apparatuses 51 and the braking force produced by the regenerative braking of the motor M, the primary functions of the braking mechanism of the control apparatus 1B are attitude control and the like. Although both share the element of braking, they achieve mutually-different functions.

### Stop Maintenance

The control apparatus 1A includes the electric parking lock apparatus 50a, as well as the ECU 24A that controls the electric parking lock apparatus 50a. The control apparatus 1B includes the electric parking brake apparatus 52, as well as the ECU 24B that controls the electric parking brake apparatus 52. Both of these can be used to keep the vehicle V in a stopped state. However, while the electric parking lock apparatus 50a is an apparatus that functions when the P range of the automatic transmission TM is selected, the electric parking brake apparatus 52 locks the rear wheel. Although both share the element of keeping the vehicle V stopped, they achieve mutually-different functions.

### Vehicle Interior Notifications

The control apparatus 1A includes the information output apparatus 43A, as well as the ECU 25A that controls the information output apparatus 43A. The control apparatus 1B includes the information output apparatus 44B, as well as the ECU 25B that controls the information output apparatus 44B. Both of these can be used to communicate information to the driver. However, while the information output apparatus 43A is, for example, a heads-up display, the information output apparatus 44B is a display apparatus such as Meters Or the like. Although both share the element of making notifications in the interior of the vehicle, they can employ mutually-different display apparatuses.

### Vehicle Exterior Notifications

The control apparatus 1A includes the information output apparatus 44A, as well as the ECU 26A that controls the information output apparatus 44A. The control apparatus 1B includes the information output apparatus 43B, as well as the ECU 23B that controls the information output apparatus 43B. Both of these can be used to communicate information outside the vehicle. However, while the information output apparatus 43A is the directional indicators (hazard lamps), the information output apparatus 44B is the brake lamps. Although both share the element of making notifications outside the vehicle, they achieve mutually-different functions.

### Differences

The control apparatus 1A includes the ECU 27A that controls the power plant 50, while the control apparatus 1B does not include an independent ECU that controls the power plant 50. In the present embodiment, both the control apparatuses 1A and 1B are independently capable of steering, braking, and maintaining a stop, and thus the vehicle can be slowed down and kept stopped while remaining in the lane even if one of the control apparatus 1A and the control apparatus 1B has experienced a drop in performance, has had its power source cut off, or has bad its communication cut off. Furthermore, as described above, the ECU 21B can output control commands to the ECU 27A via the communication line L2, the gateway GW and the communication line L1, and the ECU 21B can also control the power plant 50. Although an increase in costs can be suppressed by not providing, the control apparatus 113 with an independent ECU that controls the power plant 50, such an ECU may be provided.

### Sensor System

### Detecting Surrounding Conditions

The control apparatus 1A includes the detection units 31A and 32A. The control apparatus 1B includes the detection units 31B and 32B. Both of these can be used for recognizing the travel environment of the vehicle V. The detection unit 32A is LIDAR, and the detection unit 32B is radar. LIDAR is generally useful for detecting shapes. Radar, meanwhile, is generally more useful than LIDAR in terms of cost. By using these sensors, which have different characteristics, together, the object recognition performance can be improved, costs can be reduced, and so on. Although both the detection units 31A and 31B are cameras, cameras having different characteristics may be used. For example, one of the cameras may have a higher resolution than the other. Alternatively, the cameras may have mutually-different angles of view.

In terms of a comparison between the control apparatus 1A and the control apparatus 1B, the detection units 31A and 32A may have different detection characteristics from the detection units 31B and 32B. In the present embodiment, the detection unit 32A is LIDAR, which generally has better object edge detection performance than radar (the detection unit 32B). Additionally, radar is generally superior to LIDAR in terms of relative speed detection accuracy, weatherability, and so on.

Assuming the camera 31A is a camera having a higher resolution than the camera 31B, the detection units 31A and 32A will have better detection performance than the detection units 31B and 32B. By combining a plurality of sensors having different detection characteristics and costs, there are situations where cost advantages can be achieved in terms of the system as a whole. Additionally, by combining sensors having different detection characteristics, detection emissions, erroneous detections, and the like can be reduced more than when identical sensors are made redundant.

### Vehicle Speed

The control apparatus 1A includes the rotation number sensor 39. The control apparatus 1B includes the wheel speed sensor 38. Both of these can be used to detect the vehicle speed. However, while the rotation number sensor 39 detects the rotational speed of the output shall of the automatic transmission TM, the wheel speed sensor 38 detects the rotational speed of the wheels. Although both share the element of being able to detect the vehicle speed, they are sensors which detect different items.

### Yaw Rate

The control apparatus 1A includes the gyrosensor 33A. The control apparatus 1B includes the yaw rate sensor 33B. Both of these can be used to detect the angular velocity of the vehicle V about the vertical axis. However, while the gyrosensor 33A is used to determine the path of the vehicle V, the yaw rate sensor 33B is used to control the attitude and the like of the vehicle V. Although both share the element of being able to detect the angular velocity of the vehicle V, they are sensors which are used for mutually-different purposes.

### Steering Angle and Steering Torque

The control apparatus 1A includes a sensor that detects the rotation amount of a motor in the electric power steering apparatus 41A. The control apparatus 1B includes the steering angle sensor 37. Both of these can be used to detect the steering angle of the front wheels. In the control apparatus 1A, using a sensor that detects the rotation amount of the motor of the electric power steering apparatus 41A without additionally providing the steering angle sensor 37 makes it possible to suppress an increase in costs. That said, the steering angle sensor 37 may also be provided in the, control apparatus 1A.

Additionally, by including a torque sensor in both the electric power steering apparatuses 41A and 41B, both the control apparatuses 1A and 1B can recognize the steeling torque.

### Braking Operation Amount

The control apparatus 1A includes the operation detection sensor 34b. The control apparatus 1B includes the pressure sensor 35. Both of these can be used to detect the amount of a braking operation made by the driver. However, while the operation detection sensor 34b is used to control the distribution of the braking force produced by the four brake apparatuses 51 and the braking force produced by the regenerative braking of the motor M, the pressure sensor 35 is used in attitude control and the like. Although both share the element of detecting the braking operation amount, they are sensors used for mutually-different purposes.

### Power Sources

The control apparatus 1A receives the supply of power from the power source 7A, whereas the control apparatus 1B receives the supply of power from the power source 7B. Power is supplied to the control apparatus 1A or the control apparatus 1B even when the supply of power from the power source 7A or the power source 7B has been cut off or has decreased, and thus a more reliable power source can be ensured, which improves the reliability of the control system 1. If the supply of power from the power source 7A has been cut off or has decreased, inter-ECU communication passing through the gateway GW of the control apparatus 1A becomes difficult. However, in the control apparatus 1B, the ECU 21B can communicate with the ECUs 22B to 24B and 44B over the communication line L2.

### Redundancy within Control Apparatus 1A

The control apparatus 1A includes the ECU 20A that carries out automated driving control and the ECU 29A that carries out travel support control, and thus includes two control units that carry out travel control.

### Example of Control Functions

The control functions that can be executed by the control apparatus 1A or 1B include travel-related functions, which pertain to controlling the powering, braking, and steering of the vehicle V, and notification functions, which pertain to notifying the driver of information.

Lane keep control, lane departure suppression control (road departure suppression control), lane change control, forward vehicle following control, collision reduction braking control, unintended departure suppression control, and so on can be given as examples of travel-related functions. Nearby vehicle notification control, forward vehicle departure notification control, and so on can be given as examples of notification functions.

“Lane keep control” is one type of control for the position of the vehicle relative to a lane, and is control that causes a vehicle to automatically (without driving operations made by the driver) travel along a travel track set within a lane. “Lane departure suppression control” is one type of control for the position of the vehicle relative to a lane, which detects white lines or a center median and carries out steering automatically so the vehicle does not pass over the lines. The functions of lane departure suppression control and lane keep control differ in this mariner.

“Lane change control” is control that automatically causes the vehicle to move from one lane to an adjacent lane while the vehicle is traveling. “Forward vehicle following control” is control for automatically following another vehicle traveling in front of the self-vehicle. “Collision reduction braking control” is control that supports collision, avoidance by braking automatically when there is an increased likelihood of the vehicle colliding with an obstruction in front of the vehicle. “Unintended departure suppression control” is control, that limits acceleration of the vehicle when the driver makes an acceleration operation greater than or equal to a predetermined amount from a state in which the vehicle is stopped, and serves to suppress sudden departures.

“Nearby vehicle notification control” is control that notifies the driver of the presence of another vehicle traveling in an adjacent lane adjacent to the lane in which the self-vehicle is traveling, and, for example, notifies the driver of the presence of another vehicle traveling to the side or behind the self-vehicle. “Forward vehicle departure notification control” is control that makes a notification when the self-vehicle and another vehicle in front of the self-vehicle are stopped, and the other vehicle in front then departs. These notifications can be made by the above-described vehicle interior notification devices (the information output apparatus 43A and the information output apparatus 44B).

The ECU 20A, the ECU 29A, and the ECU 21B can share the execution of these control functions. Which control function is assigned to which ECU can be selected as appropriate.

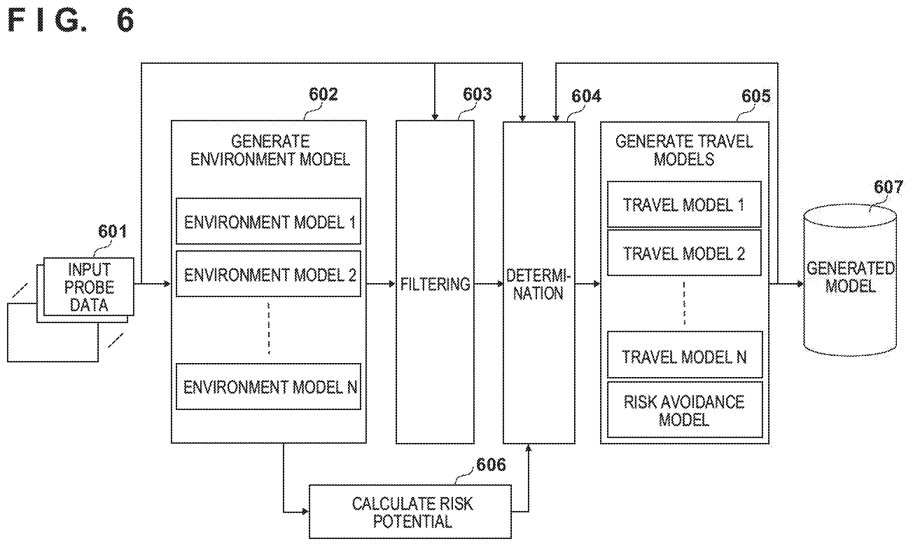

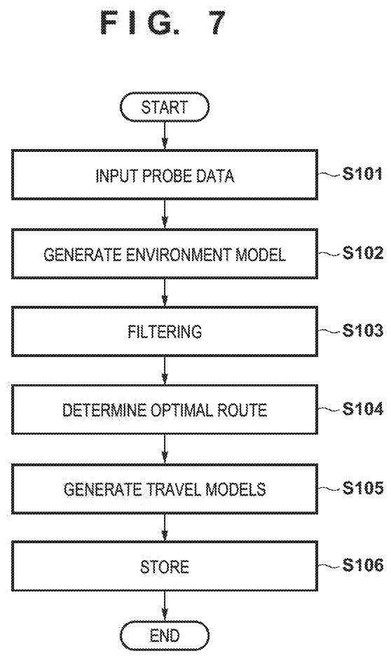

Operations of the server 101 according to the present embodiment be described next with reference to FIG. 6 and FIG. 7. FIG. 6 is a diagram illustrating a block configuration from the input of probe data to the generation of a travel model in the server 101. Blocks 601, 602, 603, 604, 605, and 606 in FIG. 6 are realized by the learning unit 205 of the server 101. A block 607 is realized by the learned data holding unit 206 of the server 101.

FIG. 7 is a flowchart illustrating processing from the input of probe data to the storage of a generated travel model. In S101, the block 601 inputs the probe data. The “probe data” input here is travel data sent from the vehicle 104. The probe data includes the vehicle movement information such as speed and acceleration, the GPS position information indicating the position of the vehicle 104, the surrounding environment information of the vehicle 104, and the driver comment information input through the HML. In S101, the probe data from each vehicle 104 is received, as illustrated in FIG. 1.

In S102, the block 602 generates an environment model on the basis of the vehicle movement information and the surrounding environment information. Here, the “surrounding environment information” is, for example, image information, detection information, and the like obtained by the detection units 31A, 31B, 32A, and 32B (cameras, radar, LIDAR) installed in the vehicle 104. Alternatively, the surrounding environment information may be obtained through vehicle-to-vehicle communication, road-to-vehicle communication, and the like. The block 602 generates environment models 1, 2, . . . , N for each of scenes such as curves, intersections, and the like, recognizes obstructions such as guard rails and medians, traffic signs, and the like, and outputs these to the block 606. On the basis of a result of the recognition by the block 602, the block 606 calculates a risk potential used to determine an optimal route, and outputs the result of that calculation to the block 604.

In S103 the block 603 carries out filtering to extract vehicle behavior subject to the determination made by the block 604, on the basis of the environment model generated by the block 602 and the vehicle movement information in the probe data. The filtering carried out in S103 will be described later.

In S104, the block 604 determines the optimal route on the basis of the vehicle behavior filtered the block 603, the risk potential calculated by the block 606, and a travel model that has already been generated and is stored in the learned data holding unit 206. The optimal route is calculated, for example, by carrying out recursive analysis on a feature amount of the vehicle behavior corresponding to the probe data collected from each vehicle 104.

In S105, the block 605 generates travel models 1 to N (basic travel models) corresponding to each of scenes on the basis of the results of the determination made by the block 604. Note that a risk avoidance model is generated for a specific scene in which it is necessary to avoid a risk. The specific scene will be described later.

In S106, the block 607 stores a generated travel model 607, which has been generated by the block 605, in the learned data holding unit 206. The stored generated travel model 607 is used in the determination made by the block 604. The processing of FIG. 7 ends after S106. In addition to being stored in the learned data holding unit 206 for use in the determination made by the block 604, the generated travel model 607 generated in S105 may also be loaded into the vehicle 104.

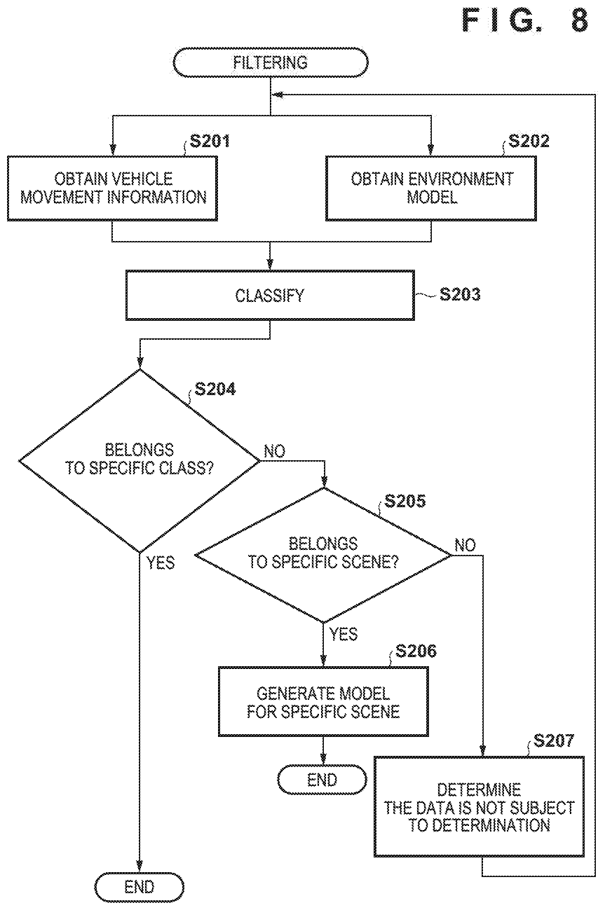

FIG. 8 is a flowchart illustrating the filtering process of S103. In S201, the block 603 obtains the vehicle movement information from the probe data input by the block 601. Then, in S202, the block 603 obtains the environment model generated by the block 602.

In S203, the block 603 classifies the feature amount of the vehicle behavior corresponding to the collected probe data. Then, in S204, the block 603 determines whether or not the feature amount of the vehicle behavior currently being handled belongs to a specific class in a sorter that has already been subjected to cluster analysis. The specific class may be determined on the basis of a determination benchmark used to determine the optimal route in S104 (e.g., a driving competence level of the driver). For example, as the driving competence level of the expert driver is set higher in advance, the reliability of the collected probe data may be determined to be higher, and more determinations of the specific class may be made. When a feature amount of vehicle behavior is determined to belong to the specific class, the process of FIG. 8 ends, and the optimal route determination of S104 is carried out. On the other hand, when it is determined that the feature amount does not belong to the specific class, the process moves to S205. In S205, the block 603 determines whether or not the feature amount of the vehicle behavior determined not to belong to the specific class belongs to a specific scene. Note that a determination that the feature amount “does not belong to the specific class” in S204 may be carried out on the basis of, for example, knowledge from abnormality detections.

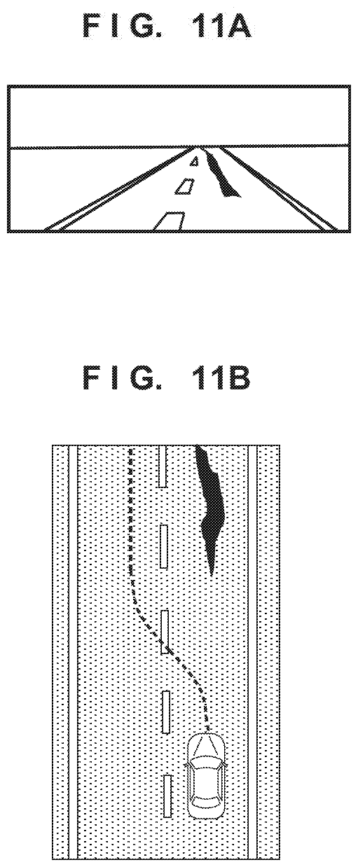

The specific scene will be described here. Even when an expert driver having a predetermined driving competence is driving the vehicle 104, it is not necessarily the case that the travel environment will remain in a constant state. For example, a situation may arise in which fissures have appeared in part of a road due to an earthquake. FIGS. 11A and 11B are diagrams illustrating a scene in which a fissure has appeared in part of a road. FIG. 11A illustrates the scene from the driver's point of view, and FIG. 11B illustrates the scene from a bird's eye view. It is assumed here that the expert driver has driven the vehicle 104 so as to avoid the fissure, as indicated by the dotted line in FIG. 11B.

Scenes such as that illustrated in FIGS. 11A and 11B are extremely rare situations, and thus it is desirable that the vehicle movement information indicated by the dotted line be excluded from the determination made by the block 604. However, it is necessary to generate a travel model indicating what sort of travel path to follow to avoid the fissure when encountering a scene such as that illustrated in FIGS. 11A and 11B. Thus in the present embodiment, the expert driver uses the HMI to input a comment such as “currently avoiding a risk” when a scene such as that illustrated in FIGS. 11A and 11B has been encountered. The vehicle 104 then sends the probe data including that comment information.

In S205, on the basis of the comment information included in the probe data the block 603 determines whether or not the feature amount of the vehicle behavior determined not to belong to the specific class belongs to a specific scene. If it is determined that the feature amount belongs to the specific scene, in S206, the block 604 carries out recursive analysis on the feature amount of the vehicle behavior, and the block 605 generates the risk avoidance model for the specific scene on the basis of a result of that analysis. After S206, the process of FIG. 8 ends, and the process of S106 is carried out.

On the other hand, if the feature amount of the vehicle behavior determined not to belong to the specific class is also determined not to belong to the specific scene, the process moves to S207. In S207, the block 603 determines that the feature amount of the vehicle behavior is not subject to the determination by the block 604. In S207, the feature amount of the vehicle behavior may be discarded, for example. After S207, the next vehicle movement information and environmental model to be handled is obtained.

Through the process of FIG. 8, a feature amount of vehicle behavior not suited to the optimal route determination can be filtered and excluded. When the excluded feature amount is suitable as a risk avoidance model, that feature amount can be extracted from the travel data received from the vehicle 104 and used to generate the risk avoidance model.

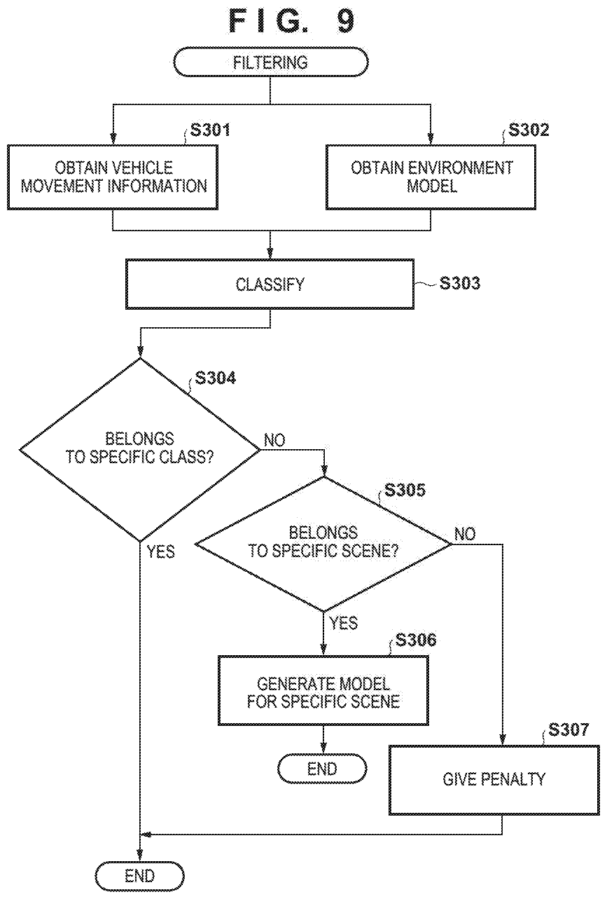

FIG. 9 is another flowchart illustrating the filtering process of S103. S301 to S306 are the same as S201 to S206 described with reference to FIG. 8, and will therefore not be described here.

In FIG. 9, if a feature amount of vehicle behavior determined not to belong to the specific class is also determined not to belong to a specific scene in S305, the block 603 gives a penalty to the feature amount of the vehicle behavior in S307. In other words, as penalty is given to the feature amount of the vehicle behavior, after which the process of FIG. 9 ends, and the optimal route determination is then carried out in S104. Using such a configuration makes it possible to prevent a drop in generalization performance in the determination made by the block 604.

In FIG. 8 and FIG. 9, the processing from S205 or S305 on is carried out for the feature amount of vehicle behavior determined not to belong to the specific class. The foregoing gives the example illustrated in FIG. 11A and FIG. 11B, and thus it is determined whether or not the travel route belongs to the specific class; however, the determination is not particularly limited to the travel route. For example, acceleration, deceleration, or the like may be subject to the determination. Such a situation corresponds to, for example, a situation where the travel environment is normal, but an animal or the like has suddenly entered the travel path. In such a case, too, referring to a comment made by the expert driver through the HMI and treating the scene as a specific scene makes it possible to generate the risk avoidance model for the specific scene in S206 and S306.

Additionally, the determination regarding the specific scene in S205 and S305 is not limited to being based on a comment made by the expert driver through the HMI. For example, a warning based on a risk avoidance model loaded in the vehicle 104, information of the brakes suddenly being operated and so on may be included in the probe data, and the feature amount of the vehicle behavior may be determined to belong to the specific scene on the basis of that information.

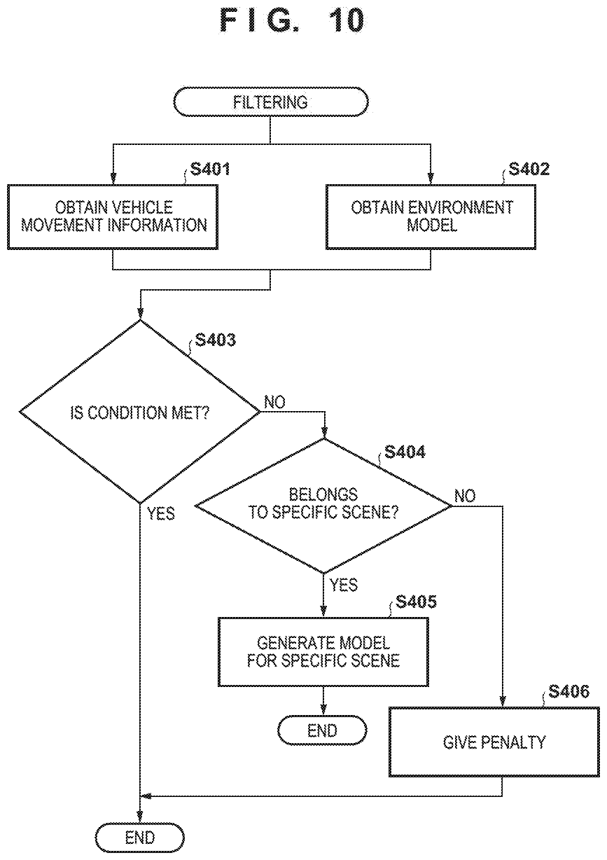

FIG. 10 is another flowchart illustrating the filtering process of S103, S401, S402, and S404 to S406 are the same as S201, S202, and S205 to S207 described with reference to FIG. 8, and will therefore not be described here.

In FIG. 8 and FIG. 9, the processing from S205 or S305 on is carried out for the feature amount of vehicle behavior determined not to belong to the specific class as a result of the classification. However, a determination method aside from one that uses the result of the classification may be used.

In S403 of FIG. 10, the block 603 determines whether or not a condition for carrying out the determination made by the block 604 is met. For example, if the risk potential of the block 606 is greater than or equal to a threshold, it is determined that the condition is not met, and the process moves to S404. This is a situation in which there is an extremely high number of pedestrians due to an event being held, for example. In this case, in S404, the risk potential is greater than or equal to a predetermined value, and thus the feature amount of the vehicle behavior may be determined to belong to a specific scene.

It is thought that in a special situation such as that described above, i.e., in a specific scene, even an expert driver will be slightly tense. Accordingly, the server 101 may collect biological information, a face image, and the like of the driver from the vehicle 104 along with the probe data. The biological information of the driver is, for example, obtained from a sensor in a location that makes contact with the driver's skin, such as the steeling wheel, and the face image is obtained, for example, from a camera provided within the vehicle. Information of the driver's line of sight may be obtained from the heads-up display and fluctuations in the line of sight may be determined as well.

If it is determined that the driver's heart rate or facial expression, the force with which he or she steps on the brake pedal or the accelerator pedal, and so on are not normal (e.g., are fluctuating), the process may move to S404 under the assumption that the condition is not met. In this case, in S404, if the risk potential is greater than or equal to a predetermined value, and thus the feature amount of the vehicle behavior may be determined to belong to a specific scene. However, if the risk potential is less than the threshold, it may be determined that the driver is simply not feeling well and a penalty may be given to the feature amount of the vehicle behavior and S406, or the feature amount may be excluded from the determination by the block 604 in the same manner as in S207.

In the present embodiment, the filtering function is configured in the server 101 rather than in the vehicle 104, and thus the configuration can easily handle a situation where characteristics of the filtering are to be changed, e.g., when the reference for determining whether or not the feature amount belongs to the specific class in S204 is to be changed.

### Summary of Embodiment

A travel model generation system according to the present embodiment is a travel model generation system that generates a travel model of a vehicle on the basis of travel data of the vehicle, and includes: an obtainment unit (S201, S202) configured to obtain the travel data from the vehicle; a filtering unit (S204) configured to exclude, from the travel data obtained by the obtainment unit, travel data to be excluded from learning; a generating unit (S104, S105) configured to learn travel data from which the travel data to be excluded from the learning has been excluded by the filtering unit and generate a first travel model on the basis of a result of the learning, and a processing unit (S206, S207, S307) configured to process the travel data excluded from the learning in accordance with a condition associated with the travel data excluded from the learning. According to such a configuration, a drop in the accuracy of the learning can be prevented, and the travel data to be excluded from learning can also be processed appropriately.

Additionally, the condition is that the vehicle is traveling in a specific scene (S205: YES); and the processing unit generates a second travel model for the travel data excluded from the learning (S206). According to such a configuration, When traveling in the specific scene, a travel model can be generated for the travel data excluded from the learning.

Additionally, in accordance with the condition, the processing unit discards (S207) the travel data excluded from the learning. According to such a configuration, travel data to be excluded from the learning can be prevented from being used in the learning.

Additionally, in accordance with the condition, the processing unit gives a penalty to the travel data excluded from the learning, and makes that travel data subject to the learning (S307). According to such a configuration, a drop in generalization performance in the learning can be prevented.

Additionally, the condition is that the vehicle is not traveling in a specific scene (S205: NO). According to such a configuration, travel data for a case where the vehicle is not traveling in travel scene can be processed appropriately.

Additionally, the system further includes a determining unit (S205) configured to determine whether or not the vehicle is traveling in the specific scene. Additionally, the determining unit determines that the vehicle is traveling in the specific scene on the basis of comment information included in the travel data (S205). According to such a configuration, it can be determined that the vehicle is traveling in the specific scene on the basis of a comment from the driver, for example.

Additionally, the determining unit determines that the vehicle is traveling in the specific scene on the basis of emergency operation information of the vehicle included in the travel data (S205). According to such a configuration, it can be determined that the vehicle is traveling in the specific scene on the basis of emergency braking operation information, for example.

Additionally, the determining unit determines that the vehicle is traveling in the specific scene on the basis of information pertaining to a driver of the vehicle included in the travel data (S205). According to such a configuration, it can be determined whether or not the vehicle is traveling in the specific scene on the basis of the driver's heart rate, for example.

Additionally, the determining unit determines that the vehicle travelling in the specific scene on the basis of a risk potential obtained from the travel data (S205). According to such a configuration, it can be determined that the vehicle is traveling in a scene where there are many pedestrians, as the specific scene, for example.

Additionally, the filtering unit excludes travel data not belonging to a specific class from the learning as a result of classifying the travel data obtained by the obtainment unit (S203, S204). According to such a configuration, travel data that does not belong to the specific class can be excluded from the learning.

The travel data obtained by the obtainment unit includes vehicle. movement information (S201). According to such a configuration, a speed, an acceleration, and a deceleration can be used in the learning, for example.

Additionally, the generating unit includes a learning unit (the block 604) configured to learn travel data; and the learning unit uses already-learned data to learn travel data from which the travel data to be excluded from the learning has been excluded by the filtering unit. According to such a configuration, the learning can be carried out using already-learned data.

### Second Embodiment

The first embodiment described a configuration in which, in the travel model generation system 100, the server 101 carries out the filtering process. The present embodiment will describe a configuration in which the vehicle 104 carries out the filtering process. The following will describe areas that are different from the first embodiment. Additionally, operations in the present embodiment are realized by, for example, a processor reading out programs stored in a storage medium and executing the programs.

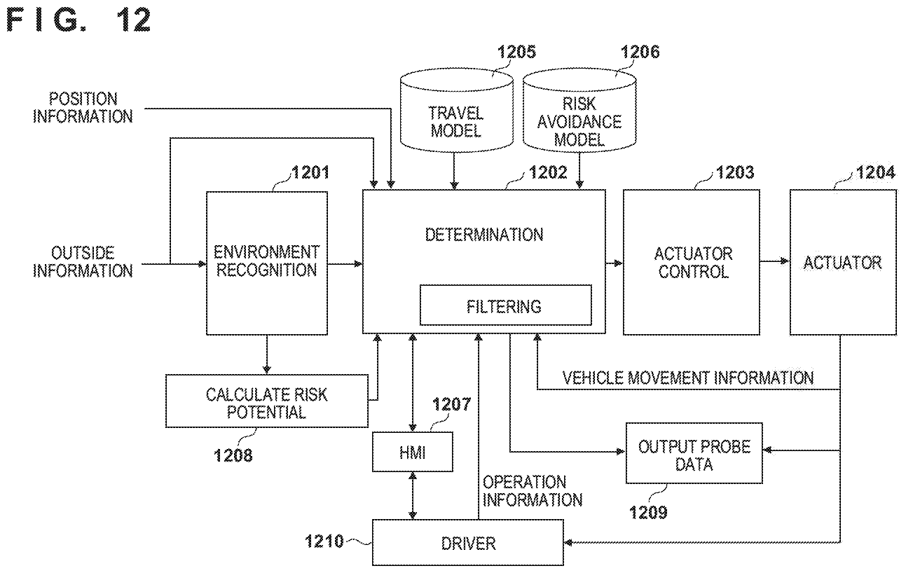

FIG. 12 is a diagram illustrating a block configuration from the obtainment of outside information to actuator control in the vehicle 104. A block 1201 in FIG. 12 is realized by, for example, the ECU 21A in FIG. 3. The block 1201 obtains the outside information of the vehicle V. Here, the “outside information” is, for example, image information, detection information, and the like obtained by the detection units 31A, 31B, 32A, and 32B installed in the vehicle 104 (cameras, radar, LIDAR). Alternatively, the outside information may be obtained through vehicle-to-vehicle communication, road-to-vehicle communication, and the like. The block 1201 recognizes obstructions such as guard rails and medians, traffic signs, and the like, and outputs results of the recognition to a block 1202 and a block 1208. The block 1208 is realized by the ECU 29A in FIG. 3, for example, calculates a risk potential used on the optimal route determination on the basis of information of obstructions, pedestrians, other vehicles, and the like recognized by the block 1201, and outputs a result of the calculation to the block 1202.

The block 1202 is realized by, for example, the ECU 29A in FIG. 3. The block 1202 determines the optimal route on the basis of the recognitions results from the outside information, the vehicle movement information such as speed and acceleration, operation information from a driver 1210 (a steering amount, an accelerator amount, and the like), and so on. At this time, a travel model 1205, a risk avoidance model 1206, and so on are taken into account. The travel model 1205, the risk avoidance model 1206, and so on are travel models generated as a result of learning, based on probe data collected in the server 101 in advance through test travel carried out by the expert driver for example. In particular, the travel model 1205 is a basic travel model generated for each of scenes such as curves, intersections, and the like, whereas the risk avoidance model 1206 is a travel model based on, for example, a sudden braking prediction for a forward vehicle, a movement prediction for a moving object such as a pedestrian, and so on. The basic travel model, the risk avoidance model, and so on generated by the server 101 are loaded into the vehicle 104 as the travel model 1205, the risk avoidance model 1206, and so on. When an automated driving support system is configured in the vehicle 104, the block 1202 determines a support amount on the basis of the operation information from the driver 1210 and a target value, and transmits that support amount to a block 1203.

The block 1203 is realized by, for example, the ECUs 22A, 21A, 24A, and 27A in FIG. 3. For example, a control amount of an actuator is determined on the basis of the optimal route determined by the block 1202, the support amount, and so on. An actuator 1204 includes systems for steering, braking, maintaining a stop, vehicle interior notifications, and vehicle exterior notifications. A block 1207 is the HMI (human-machine interface), which is an interface with the driver 1210, and is realized by the input apparatuses 45A and 45B and the like. The block 1207 makes notifications regarding switches between an automated driving mode and a driver-driven mode, receives comments from the driver when the vehicle 104 is driven by an expert driver as described above and probe data is being transmitted, and so on, for example. The comments are sent as part of the probe data. A block 1209 sends the vehicle movement information detected by various sensors such as those described with reference to FIG. 3 to FIG. 5 as the probe data, and is realized by the communication apparatus 28c.

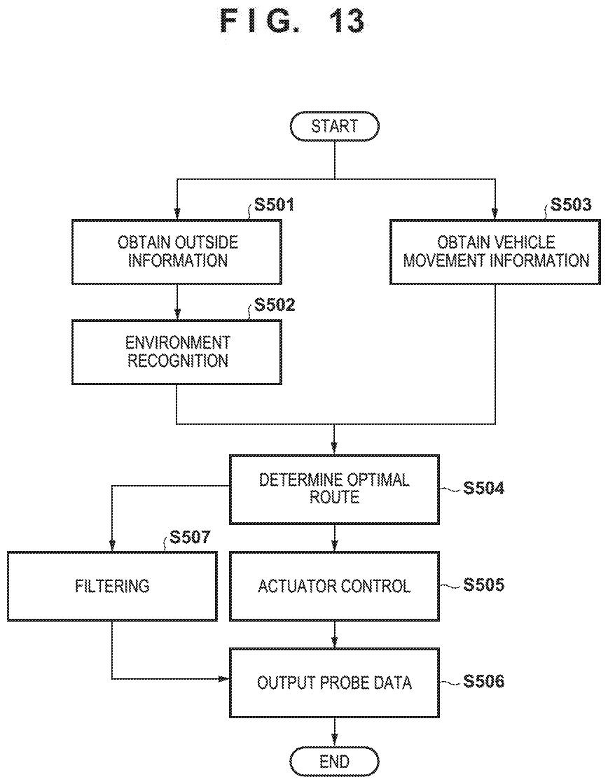

FIG. 13 is a flowchart illustrating processing leading up to probe data output. In S501, the block 1201 obtains the outside information of the vehicle 104. Here, the outside information of the vehicle V includes, for example, information obtained by the detection units 31A, 31B, 32A, and 32B (cameras, radar, and LIDAR), information obtained through vehicle-to-vehicle communication and road-to-vehicle communication, and so on. In S502, the block 1201 recognizes the outside environment including obstructions such as guard rails and medians, traffic signs, and the like, and outputs results of the recognition to the block 1202 and the block 1208. In S503, the block 1202 obtains the vehicle movement information from the actuator 1204.

In S504, the block 1202 determines the optimal route on the basis of each piece of obtained information, the travel model 1205 and the risk avoidance model 1206. For example, when the automated driving support system is configured in the vehicle 104, the support amount is determined on the basis of the operation information from the driver 1210. In S505, the block 1203 controls the actuator 1204 on the basis of the optimal route determined in S504. In S506, the block 1209 outputs (sends) the vehicle movement information detected by the various sensors as the probe data.

In S507, the block 1202 filters feature amounts of vehicle behavior subject to the probe data output by the block 1209 on the basis of the determined optimal route. The filtering carried out in S507 will be described later.

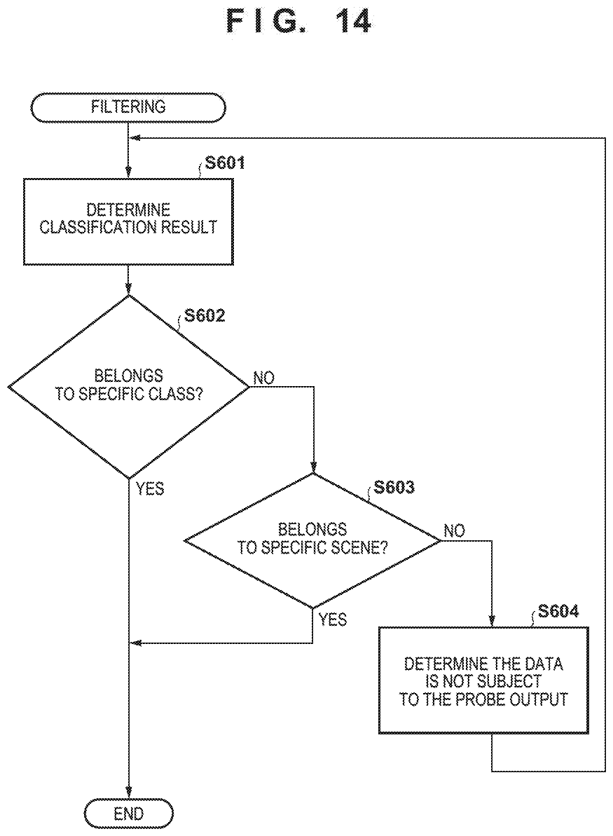

FIG. 14 is a flowchart illustrating the filtering process of S507. In S601, the block 1202 classifies the travel model 1205 on the basis of the feature amount of the vehicle behavior subject to the determination of S504, and determines whether or not the feature amount belongs to a specific class. In S602, if it is determined, as a result of the classification, that the feature amount belongs to the specific class, the process of FIG. 14 ends, and the probe data is output in S506. On the other hand, if it is determined in S602 that the feature amount does not belong to the specific class, the process moves to S603. In S603, the block 1202 determines whether or not the feature amount of the vehicle behavior determined not to belong to the specific class belongs to a specific scene. The block 1202 determines whether or not the feature amount belongs to the specific scene by referring to the comment information received from the driver 1210 through the HMI, for example. If it is determined that the feature amount belongs to the specific scene, the process of FIG. 14 ends, and the probe data is output in S506. The aforementioned comment information is included in the probe data in this case. In this case, the server 101 may generate the risk avoidance model for the specific scene by receiving that probe data. Alternatively, the classification may be carried out with the probe data from another vehicle 104, and the risk avoidance model for the specific scene may be generated if the model is determined not to belong to the specific class, as in the first embodiment.

On the other hand, if it is determined in S603 that the feature amount does not belong to the specific scene, in S604, the block 1202 excludes the feature amount of the vehicle behavior from the probe data output in S506. In S604, the feature amount of the vehicle behavior may be discarded, for example. After S604, the process of S601 is carried out, focusing on the vehicle behavior for the optimal route to be focused on next.

Through the process of FIG. 14, a feature amount of vehicle behavior not suited to the creation of a travel model by the server 101 can be filtered and excluded. If the excluded feature amount is suited to the creation of a risk avoidance model by the server 101, that feature amount can be transmitted to the server 101. Additionally, the amount of probe data transmitted to the wireless base station 103 can be reduced through the process of FIG. 14.

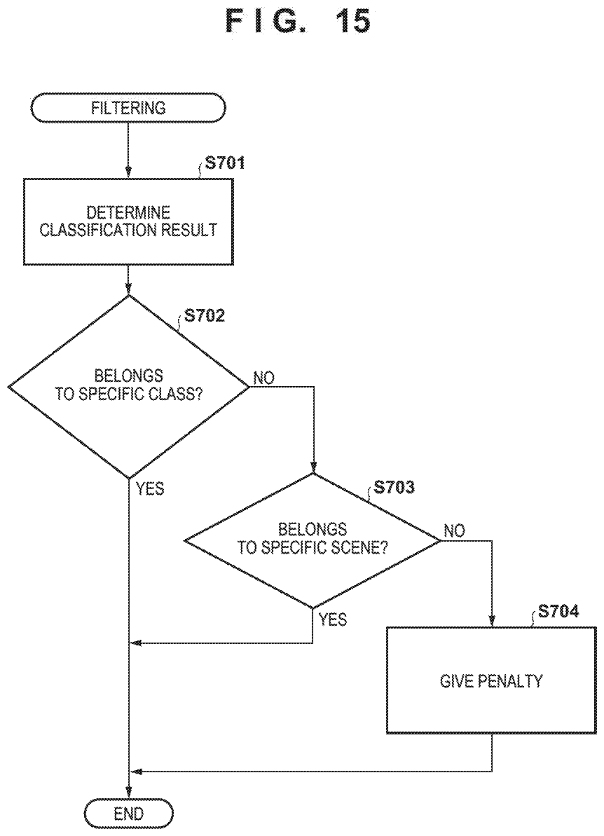

FIG. 15 is another flowchart illustrating the filtering process of S507. S701 to S703 are the same as S601 to S603 described with reference to FIG. 14, and will therefore not be described here.

In FIG. 15, if it is determined that the feature amount does not belong to the specific scene in S703, the block 1202 gives a penalty to the feature amount of the vehicle behavior in S704. In other words, a penalty is given to the feature amount of the vehicle behavior, after which the process of FIG. 15 ends, and the probe data is output in S506. As a result, a drop in generalization performance in the determination made by the block 604 of the server 101 can be prevented.

It may be determined whether or not the travel route belongs to the specific class in FIG. 14 and FIG. 15, or whether or not the acceleration, deceleration, or the like belongs to the specific class, in the same manner as in the first embodiment. Additionally, the determinations in S603, S703, and the like may be based on a comment from the expert driver made through the HMI. For example, it may be determined whether or not the feature amount of the vehicle behavior belongs to the specific scene on the basis of a warning based on a risk avoidance model loaded in the vehicle 104, information of the brakes suddenly being operated, and so on. In this case, the warning, the information of the brakes suddenly being operated, and so on are included in the probe data.

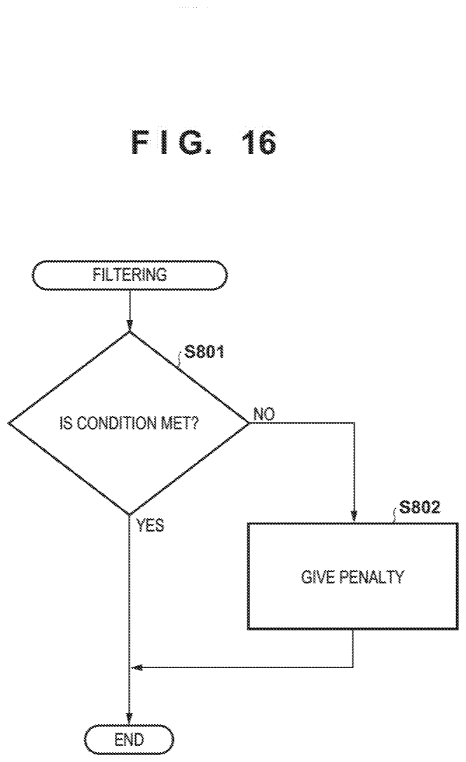

FIG. 16 is another flowchart illustrating the filtering process of S507.

In FIG. 14 and FIG. 15, the processing from S603 or S703 on is carried out for the feature amount of vehicle behavior determined not to belong to the specific class as a result of the classification. However, a determination method aside from one that uses the result of the classification may be used.

In FIG. 16, in S801, the block 1202 determines whether or not a condition for outputting the probe data is met. For example, if it is determined that the driver's heart rate or facial expression, the force with which he or she steps on the brake pedal or the accelerator pedal, and so on are not normal (e.g., are fluctuating), and the risk potential is less than a threshold, it may be determined that the driver is simply not feeling well, and the process may move to S802 under the assumption that the condition is not met. In this case, in S802, a penalty is given to the feature amount of the vehicle behavior, or the feature amount is excluded from the probe data output in the same manner as in S604.

### Summary of Embodiment

A vehicle in a travel model generation system according to the present embodiment is a vehicle in a travel model generation system that generates a travel model of a vehicle on the basis of travel data of the vehicle, the vehicle including: an obtainment unit (S501, S503) configured to obtain the travel data from the vehicle; a filtering unit (S602) configured to exclude, from the travel data obtained by the obtainment unit, travel data to be excluded from learning in a travel model generating apparatus that generates the travel model of the vehicle; a transmitting unit (S602: NO; S506) configured to transmit, to the travel model generating apparatus, travel data from which the travel data to be excluded from the learning has been excluded by the filtering unit; and a processing unit (S603, S604, S704) configured to process the travel data excluded from the learning in accordance with a condition associated with the travel data excluded from the learning. According to such a configuration, a drop in the accuracy of the learning can be prevented, and the travel data to be excluded from learning can also be processed appropriately.

Additionally, the condition is that the vehicle is traveling in a specific scene (S603: YES); and the processing unit transmits information of travel in the specific scene along with the travel data excluded from the learning to the travel model generating apparatus (S603: YES; S506). According to such a configuration when traveling in the specific scene, the travel data excluded the learning can be transmitted to the travel model generating apparatus.

Additionally, in accordance with the condition, the processing unit discards (S604) the travel data excluded from the learning. According to a configuration travel data to be excluded from the learning can be prevented from being used in the learning.

Additionally, in accordance with the condition, the processing unit gives a penalty to the travel data excluded from the learning, and transmits that travel data to the travel model generating apparatus (S704). According to such a configuration, a drop in generalization performance in the learning can be prevented.

Additionally, the condition is that the vehicle is not traveling in a specific scene (S603: NO). According to such a configuration, travel data for a case where the vehicle is not traveling in the specific scene can be processed appropriately.

Additionally, the system further includes a determining unit (S603) configured to determine whether or not the vehicle is traveling in a specific scene. Additionally, the determining unit determines that the vehicle is traveling in the specific scene on the basis of comment information included in the travel data (S603). According to such a configuration, it can be determined that the vehicle is traveling in the specific scene on the basis of a comment from the driver, for example.

Additionally the determining unit determines that the vehicle is traveling in the specific scene on the basis of emergency operation information of the vehicle included in the travel data (S603). According to such a configuration, it can be determined that the vehicle is traveling in the specific scene on the basis of emergency braking operation information, for example.

Additionally, the determining unit determines that the vehicle is traveling in the specific scene on the basis of information pertaining to a driver of the vehicle included in the travel data (S603). According to such a configuration, it can be determined whether or not the vehicle is traveling in the specific scene on the basis of the driver's heart rate, for example.

Additionally, the determining unit determines that the vehicle is traveling in the specific scene on the basis of a risk potential obtained from the travel data (S603). According to such a configuration, it can be determined that the vehicle is traveling in a scene where there are many pedestrians, as the specific scene, for example.

Additionally, the filtering unit excludes travel data not belonging to a specific class from the learning as a result of classifying the travel data obtained by the obtainment unit (S601, S602). According to such a configuration, travel data that does not belong to the specific class can be excluded from the learning.

Additionally, the travel data obtained by the obtainment unit includes vehicle movement information (S503). According to such a configuration, a speed, an acceleration, and a deceleration can be used in the learning, for example.

The present invention is not limited to the above embodiments, and various changes and modifications can be made within the spirit and scope of the present invention. Therefore, to apprise the public of the scope of the present invention, the following claims are made.

What is claimed is:

1. A travel model generation system that generates a travel model of a vehicle on the basis of travel data of the vehicle, the system comprising:
an obtainment unit configured to obtain the travel data from the vehicle;
a filtering unit configured to exclude, from the travel data obtained by the obtainment unit, travel data to be excluded from learning;
a generating unit configured to learn travel data from which the travel data to be excluded from the learning has been excluded by the filtering unit and generate a first travel model on the basis of a result of the learning; and
a processing unit configured to process the travel data excluded from the learning in accordance with a condition associated with the travel data excluded from the learning.

2. The travel model generation system according to claim 1, wherein
the condition is that the vehicle is traveling in a specific scene; and
the processing unit generates a second travel model for the travel data excluded from the learning.

3. The travel model generation system according to claim 1, wherein
in accordance with the condition, the processing unit discards the travel data excluded from the learning.

4. The travel model generation system according to claim 1, wherein
in accordance with the condition, the processing unit gives a penalty to the travel data excluded from the learning, and makes that travel data subject to the learning.

5. The travel model generation system according to claim 3, wherein
the condition is that the vehicle is not traveling in a specific scene.

6. The travel model generation system according to claim 2, further comprising
a determining unit configured to determine whether or not the vehicle is traveling in the specific scene.

7. The travel model generation system according to claim 6, wherein
the determining unit determines that the vehicle is traveling in the specific scene on the basis of comment information included in the travel data.

8. The travel model generation system according to claim 6, wherein
the determining unit determines that the vehicle is traveling in the specific scene on the basis of emergency operation information of the vehicle included in the travel data.

9. The travel model generation system according to claim 6, wherein
the determining unit determines that the vehicle is traveling in the specific scene on the basis of information pertaining to a driver of the vehicle included in the travel data.

10. The travel model generation system according to claim 6, wherein
the determining unit determines that the vehicle is traveling in the specific scene on the basis of a risk potential obtained from the travel data.

11. The travel model generation system according to claim 1, wherein
the filtering unit excludes travel data not belonging to a specific class from the learning as a result of classifying the travel data obtained by the obtainment unit.

12. The travel model generation system according to claim 11, wherein
the travel data obtained by the obtainment unit includes vehicle movement information.

13. The travel model generation system according to claim 1, wherein
the generating unit includes a learning unit configured to learn travel data; and
the learning unit uses already-learned data to learn travel data from which the travel data to be excluded from the learning has been excluded by the filtering unit.

14. A vehicle in a travel model generation system that generates a travel model of a vehicle on the basis of travel data of the vehicle, the vehicle comprising:
an obtainment unit configured to obtain the travel data from the vehicle;
a filtering unit configured to exclude, from the travel data obtained by the obtainment unit, travel data to be excluded from learning in a travel model generating apparatus that generates the travel model of the vehicle;
a transmitting unit configured to transmit, to the travel model generating apparatus, travel data from which the travel data to be excluded from the learning has been excluded by the filtering unit; and
a processing unit configured to process the travel data excluded from the learning in accordance with a condition associated with the travel data excluded from the learning,

15. The vehicle according to claim 14, wherein
the condition is that the vehicle is traveling in a specific scene; and
the processing unit transmits information of travel in the specific scene along with the travel data excluded from the learning to the travel model generating apparatus.

16. The vehicle according to claim 14, wherein
in accordance with the condition, the processing unit discards the travel data excluded from the learning.

17. The vehicle according to claim 14, wherein
in accordance with the condition, the processing unit gives a penalty to the travel data excluded from the learning, and transmits that travel data to the travel model generating apparatus.

18. The vehicle according to claim 16, wherein
the condition is that the vehicle is not traveling in a specific scene.

19. The vehicle according to claim 15, further comprising
a determining unit configured to determine whether or not the vehicle is traveling in a specific scene.

20. The vehicle according to claim 14, wherein
the filtering unit excludes travel data not belonging to a specific class from the learning as a result of classifying the travel data obtained by the obtainment unit.

21. A processing method executed in a travel model generation system that generates a travel model of a vehicle on the basis of travel data of the vehicle, the method comprising:
an obtainment step of obtaining the travel data from the vehicle;
a filtering step of excluding, from the travel data obtained in the obtainment step, travel data to be excluded from learning;
a generating step of learning travel data from which the travel data to be excluded from the learning has been excluded in the filtering step and generating a first travel model on the basis of a result of the learning; and
a processing step of processing the travel data excluded from the learning in accordance with a condition associated with the travel data excluded from the learning.

22. A processing method executed in a vehicle of a travel model generation system that generates a travel model of a vehicle on the basis of travel data of the vehicle, the method comprising:
an obtainment step of obtaining the travel data from the vehicle;
a filtering step of excluding, from the travel data obtained in the obtainment step, travel data to be excluded from learning in a travel model generating apparatus that generates the travel model of the vehicle;
a transmitting step of transmitting, to the travel model generating apparatus, travel data from which the travel data to be excluded from the learning has been excluded in the filtering step; and
a processing step of processing the travel data excluded from the learning in accordance with a condition associated with the travel data excluded from the learning.
